(19) United States
(12) Patent Application Publication
(10) Pub. No.: US 2015/0212025 A1
(43) Pub. Date: Jul. 30, 2015

(54) Harness Diagnostics System for a Machine

(71) Applicant: Caterpillar Inc., Peoria, IL (US)

(72) Inventors: Igor A. Francis-Buller, Peoria, IL (US); Lonny E. Johnson, Peoria, IL (US)

(73) Assignee: Caterpillar Inc., Peoria, IL (US)

(21) Appl. No.: 14/168,762

(22) Filed: Jan. 30, 2014

(51) Int. Cl. G01N 27/02

(52) U.S. Cl. CPC G01N 27/02

(57) ABSTRACT

A diagnostics system includes a controller to scan impedance along electrical paths of a wiring harness assembly to generate scanned impedance data and compare the scanned impedance data to corresponding baseline impedance data. Upon an impedance deviation between the scanned and baseline data exceeding a predetermined amount, the location along the electrical paths corresponding to the impedance deviation is determined, and the operating conditions of the machine corresponding to the timing of the scan is stored. Portions of the electrical schematic related to the location of the impedance deviation is identified and may be displayed.

### TECHNICAL FIELD

This disclosure relates generally to a diagnostics system and, more particularly, to a diagnostics system for monitoring a wiring harness assembly of a machine.

### BACKGROUND

Many machines include components and systems that are electrically connected by bundles of conductors such as wires. Each wire is typically are surrounded by insulation and a group of wires may be bundled together as part of a multi-wire cable. As the wires age, the insulation may break down and/or become worn such that the conductor of a wire may contact the conductor of an adjacent wire or another conductive structure, such as the frame of the machine. In an addition, conductive strands of aging wires may separate and tear due to vibration, shock and stress on the wires. Still further, stress due to pinching, rubbing, moisture, corrosion, and/or excessive heat may also pose risks that can lead to wire damage.

Connections between wires and components may be made directly or the wires may be terminated or connected to connectors that are subsequently connected to the components. Over time, when subjected to the same environmental conditions as the conductors, and when subjected to numerous connection and disconnection cycles, some of the connections between the wires and the connectors may become loose or otherwise degrade. In addition, the direct connections between the wires and components may also fail or otherwise degrade. Finally, components that are attached to the wiring may also fail over time.

When faults or degradation occur in any aspect of a wiring harness assembly (such as the wiring, the connectors, or components connected to the wiring), operation of the machine may be affected. A fault in any aspect of the wiring harness assembly may be result in a machine fault in which some aspect of the machine does not operate as desired. Rapid detection and resolution of any faults is desirable to minimize any downtime of the machine. However, detecting the location of a fault is often time consuming and may be particularly challenging or even impossible when the fault occurs only intermittently. As a result, in some instances, entire systems or portions of the wiring harness assembly may be replaced unnecessarily in an attempt to repair a fault in some aspect of the wiring harness assembly. Accordingly, systems such as reflectometry systems have been developed in which a signal is sent or directed down an electrical path and reflected signals are analyzed to determine the location of any faults in the wiring harness assembly.

U.S. Pat. No. 7,548,071 discloses a system that utilizes a spread spectrum reflectometry system to test a signal path. The system generates a test signal based on a probe pseudo-noise sequence and the response signal is measured. The system may be implemented in a compact form factor such as on an integrated circuit.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a diagnostics system for use with a wiring harness assembly mounted on a machine includes a plurality of sensor systems for determining operating conditions of the machine and a scanning system for determining impedance along an electrical path of the wiring harness assembly. A controller is configured to (a) store a plurality of sets of baseline impedance data, with each set of baseline impedance data corresponding to one of a plurality of electrical paths of the wiring harness assembly, (b) store an electrical schematic of the wiring harness assembly, and (c) determine the operating conditions of the machine based upon the plurality of sensor systems. The controller is further configured to (d) scan impedance along a selected one of the plurality of electrical paths of the wiring harness assembly to generate scan data, (e) generate a set of scanned impedance data from the scan data, (f) compare the set of scanned impedance data to a selected one of the plurality of sets of baseline impedance data, with the selected one of the plurality of sets of baseline impedance data corresponding to the selected one of the plurality of electrical paths of the wiring harness assembly, and (g) upon an impedance deviation between the set of scanned impedance data and the set of baseline impedance data exceeding a predetermined amount: (i) determine a location along the selected one of the plurality of electrical paths of the wiring harness assembly corresponding to the impedance deviation, and (ii) store the plurality of operating conditions of the machine corresponding to a time at which the scan data was generated. The controller is also configured to repeat steps (c)-(g) until each of the plurality of electrical paths of the wiring harness assembly has been scanned, and identify portions of the electrical schematic related to the location along the selected one of the plurality of electrical paths of the wiring harness assembly corresponding to the impedance deviation.

In another aspect, a controller-implemented method of operating a diagnostics system for use with a wiring harness assembly mounted on a machine includes (a) storing a plurality of sets of baseline impedance data, with each set of baseline impedance data corresponding to one of a plurality of electrical paths of the wiring harness assembly, (b) storing an electrical schematic of the wiring harness assembly, (c) determining the operating conditions of the machine based upon a plurality of sensor systems, and (d) scanning impedance along a selected one of the plurality of electrical paths of the wiring harness assembly to generate scan data. The method further includes (e) generating a set of scanned impedance data from the scan data, (f) comparing the set of scanned impedance data to a selected one of the plurality of sets of baseline impedance data, with the selected one of the plurality of sets of baseline impedance data corresponding to the selected one of the plurality of electrical paths of the wiring harness assembly, and (g) upon an impedance deviation between the set of scanned impedance data and the set of baseline impedance data exceeding a predetermined amount: (i) determining a location along the selected one of the plurality of electrical paths of the wiring harness assembly corresponding to the impedance deviation, and (ii) storing the plurality of operating conditions of the machine corresponding to a time at which the scan data was generated. The method further includes repeating steps (c)-(g) until each of the plurality of electrical paths of the wiring harness assembly has been scanned, and identifying portions of the electrical schematic related to the location along the selected one of the plurality of electrical paths of the wiring harness assembly corresponding to the impedance deviation.

In still another aspect, a machine includes a frame, a prime mover associated with the frame, a wiring harness assembly mounted on the machine and including a plurality of electrical paths, a plurality of sensor systems for determining operating conditions of the machine, and a scanning system for determining impedance along each of the electrical paths of the wiring harness assembly. A controller is configured to (a) store a plurality of sets of baseline impedance data, with each set of baseline impedance data corresponding to one of a plurality of electrical paths of the wiring harness assembly, (b) store an electrical schematic of the wiring harness assembly, and (c) determine the operating conditions of the machine based upon the plurality of sensor systems. The controller is further configured to (d) scan impedance along a selected one of the plurality of electrical paths of the wiring harness assembly to generate scan data, (e) generate a set of scanned impedance data from the scan data, (f) compare the set of scanned impedance data to a selected one of the plurality of sets of baseline impedance data, with the selected one of the plurality of sets of baseline impedance data corresponding to the selected one of the plurality of electrical paths of the wiring harness assembly, and (g) upon an impedance deviation between the set of scanned impedance data and the set of baseline impedance data exceeding a predetermined amount: (i) determine a location along the selected one of the plurality of electrical paths of the wiring harness assembly corresponding to the impedance deviation, and (ii) store the plurality of operating conditions of the machine corresponding to a time at which the scan data was generated. The controller is also configured to repeat steps (c)-(g) until each of the plurality of electrical paths of the wiring harness assembly has been scanned, and identify portions of the electrical schematic related to the location along the selected one of the plurality of electrical paths of the wiring harness assembly corresponding to the impedance deviation.

### BRIEF DESCRIPTION OF THE DRAWINGS

FIG. 1 is a side elevational view of a machine constructed in accordance with the disclosure;

FIG. 2 is a schematic view of a wiring harness assembly including a diagnostics system in accordance with the disclosure;

FIG. 3 is a schematic view of an alternate embodiment of a wiring harness assembly including a diagnostics system in accordance with the disclosure;

FIG. 4 is a perspective view of a wiring harness assembly for use in a cab of a machine;

FIG. 5 is a schematic view of a portion of the diagnostics system in accordance with the disclosure;

FIG. 6 is an exemplary graph of voltage as a function of time along a hypothetical electrical path of wiring harness assembly;

FIG. 7 is a flowchart illustrating a process of monitoring a machine and scanning electrical paths of a wiring harness assembly; and

FIG. 8 is a flowchart illustrating a process of using the scanned data and identifying relevant information based upon the scanned data.

### DETAILED DESCRIPTION

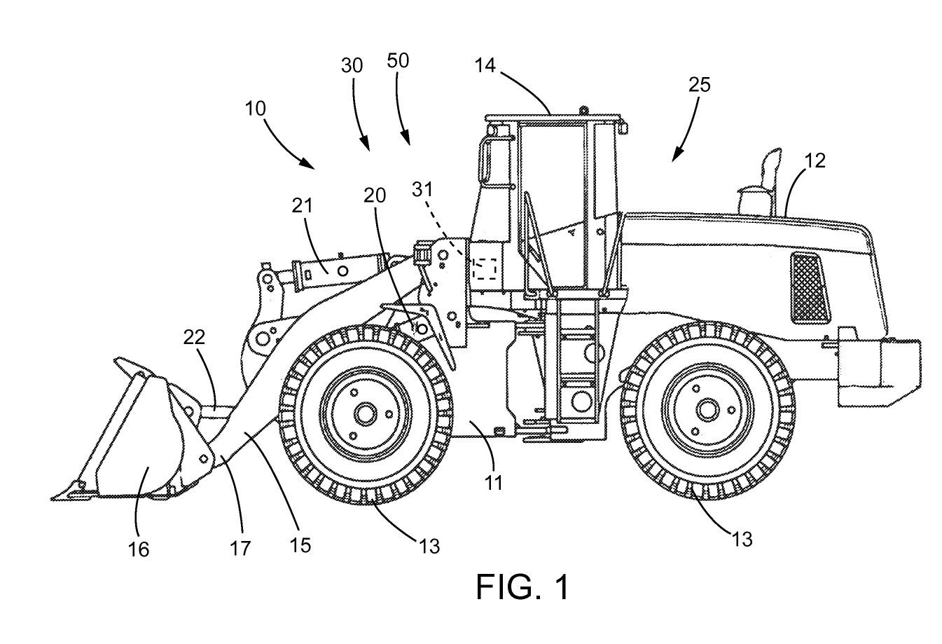

FIG. 1 is a diagrammatic illustration of machine 10 such as a wheel loader that may be used in accordance with an embodiment of the disclosure. While the machine 10 is depicted as a wheel loader, it is to be understood that the teachings of this disclosure apply to many other machines regardless of the type of machine. The machine 10 may include a chassis 11 and a prime mover such as an engine 12. The chassis 11 may be supported by wheels 13 that are operatively driven, directly or indirectly, by the engine 12. The chassis 11 may also support an operator station or cab 14, and one or more lift arms 15 pivotally connected to the chassis 11. An implement 16 configured for movement relative to the machine may be provided at a distal end 17 of the lift arms 15. Implement 16 may be any type of implement such as a ground engaging implement (e.g., a bucket) or an implement that may not engage the ground (e.g., a fork arrangement).

An operator may physically occupy cab 14 and provide input to control the machine. Cab 14 may include one or more input devices (not shown) through which an operator issues commands to control the propulsion and steering of the machine 10 as well as operate various implements associated with the machine.

An electro-hydraulic system may be provided on machine 10 for moving the implement 16 relative to the machine. More specifically, one or more lift cylinders 20 may operatively connect the chassis 11 to the lift arms 15 to facilitate raising and lowering of the lift arms. One lift cylinder 20 may be provided for each lift arm 15, if desired. The lift cylinders 20 may be hydraulic cylinders operatively connected to the hydraulic system (not shown) of the machine 10. One or more tilt cylinders 21 may operatively connect the implement 16 to the chassis 11 to facilitate rotation of the implement 16 relative to the lift arms 15. The tilt cylinders 21 may be hydraulic cylinders operatively connected to the hydraulic system. The electro-hydraulic system may also be configured to operate other systems such as the steering system.

Machine 10 may further include a plurality of additional systems that utilize electrical signals to control their operation. These additional systems may include the powertrain, payload control systems, position sensing systems, vision and other safety systems, operator comfort systems, and any other desired systems.

Each of these electrically controlled systems may include one or more sensor systems indicated generally at 25 that provide data indicative (directly or indirectly) of the performance and/or operating conditions of various aspects of the machine 10. The term “sensor system” is meant to be used in its broadest sense to include one or more sensors and related components that may be associated with the machine 10 and that may cooperate to sense various functions, operations, and operating characteristics of the machine.

In one example, a sensor system may be a machine position sensor system associated with the machine 10 for determining the position of the machine relative to a worksite or relative to an earth reference. In another example, a sensor system may be an implement position sensor system for determining the position of the implement 16. Still other examples may include sensor systems for sensing movement of the machine 10 such as the pitch rate and acceleration of the machine 10, together with sensor systems for determining the operating speed of the prime mover, the temperature of various fluids of the machine, the pressure at various locations within the hydraulic system, and the status of various components.

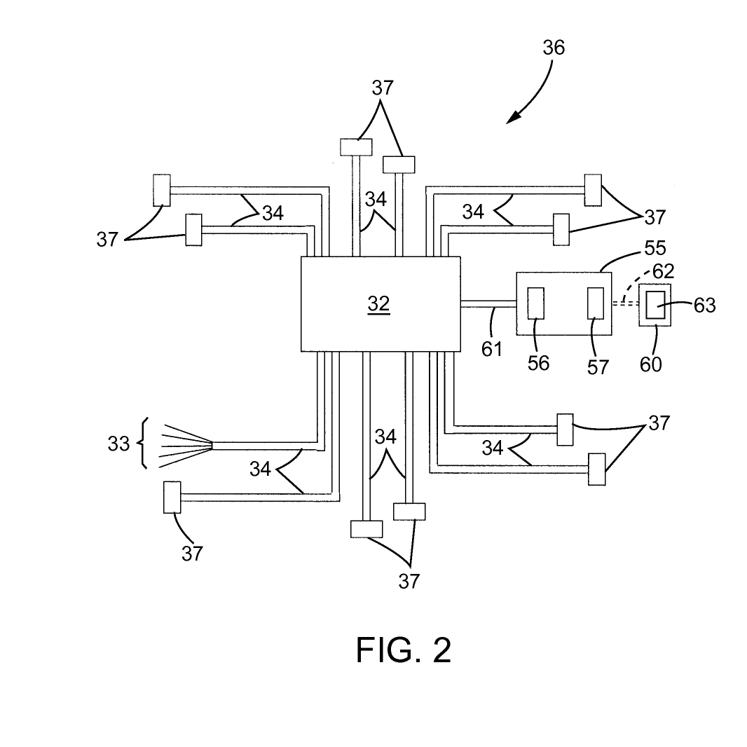

A control system 30 may be provided to control the operation of the machine 10. The control system 30, as shown generally by an arrow in FIG. 1 indicating association with the machine 10, may include an electronic control module such as controller 31. The controller 31 may receive operator input command signals and control the operation of the various systems of the machine 10. The control system 30 may include one or more input devices (not shown) to control the machine 10 and one or more sensor systems to provide data and other input signals representative of various operating parameters of the machine 10. The control system 30 and controller 31 may be located on the machine 10 or may be distributed with components thereof also located remotely from the machine unless the context of the usage dictates that the components are specifically located on or off the machine. The functionality of control system 30 may be distributed so that certain functions are performed at machine 10 and other functions are performed remotely. In such case, the control system 30 may include a communications system such as wireless network system (not shown) for transmitting signals between the machine 10 and a system located remote from the machine. In another example, some of the functionality of control system 30 may be performed by machine 10 and other functions may be performed on a portable computing device 60 (FIG. 2).

The controller 31 may be an electronic controller that operates in a logical fashion to perform operations, execute control algorithms, store and retrieve data and other desired operations. The controller 31 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry.

The controller 31 may be a single controller or may include more than one individual controller disposed about machine 10 to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 31 may be implemented in hardware and/or software without regard to the functionality. The controller 31 may rely on one or more data maps relating to the operating conditions of the machine 10 that may be stored in the memory of controller. Each of these maps may include a collection of data in the form of tables, graphs, and/or equations.

Each of the electrical or electronic components of machine 10, including the sensor systems 25 and any on-board controllers such as main controller 32, may be electrically interconnected by a plurality of electrically conductive wires 33 or multi-wire cables 34 as depicted in FIG. 2. A group of such electrically conductive wires 33 and/or multi-wire cables 34 is sometimes referred to as a wiring harness or a wiring harness assembly. As used herein, the phrase “wiring harness assembly” (generally designated 36) refers to a plurality of electrically conductive wires 33 and/or multi-wire cables 34 that are electrically connected to additional electrical or electronic components 37 that control or provide functionality to the machine 10, provide information to/from the machine, and/or connect wires or cables to other components on or associated with the machine. Each electrical path of the wiring harness assembly 36 includes an electrical conductor such as electrically conductive wire 33 together with various electrical or electronic components that are electrically connected to the wire. As a result, the wiring harness assembly 36 includes a plurality of electrical paths.

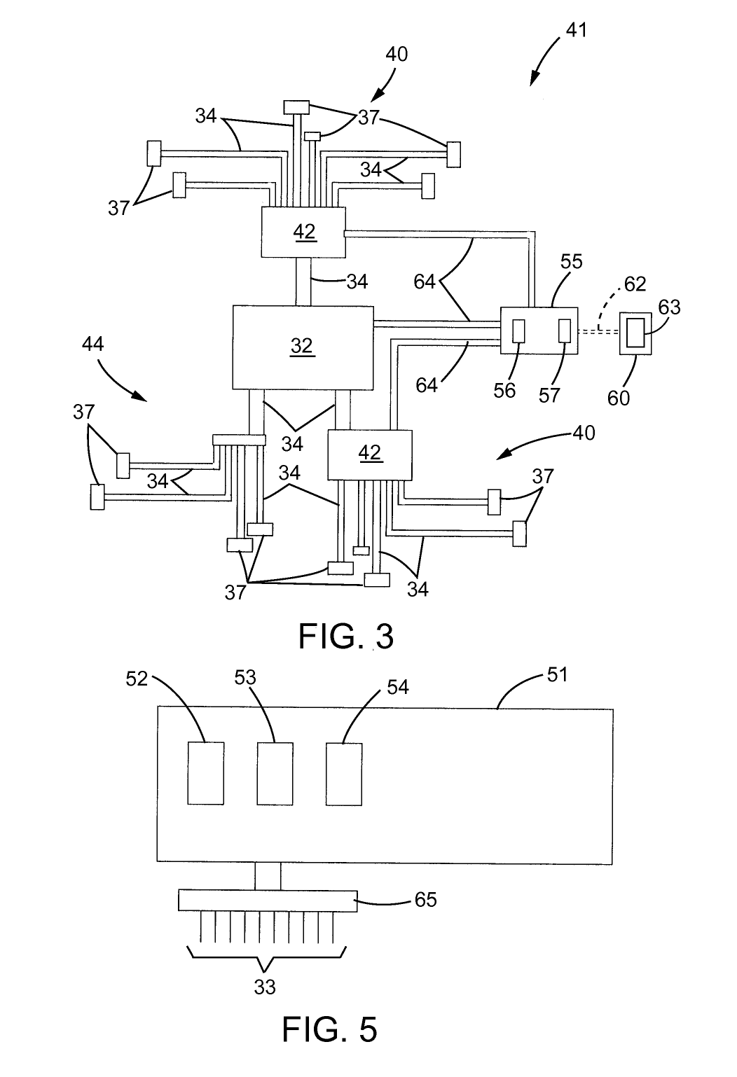

Machine 10 may include a single wiring harness assembly 36 as depicted in FIG. 2 or may include a plurality of sub-assemblies or wiring harness sub-assemblies 40 that are interconnected to form a larger wiring harness assembly generally designated 41 in FIG. 3. Each of the wiring harness sub-assemblies 40 may be dedicated to a single function (e.g., engine control, hydraulics control) or a single physical location on the machine 10 (e.g., cab 14), or may serve any other desired purpose. In some instances, the wiring harness sub-assemblies 40 may include one or more individual on-board controllers such as sub-assembly controllers 42 that are electrically connected by multi-wire cable 34 to a main controller 32 associated with the machine 10. In other instances, a wiring harness sub-assembly, such as the one designated generally as 44 in FIG. 3, may not include a sub-assembly controller 42 and may be electrically connected to the main controller 32 of the machine 10.

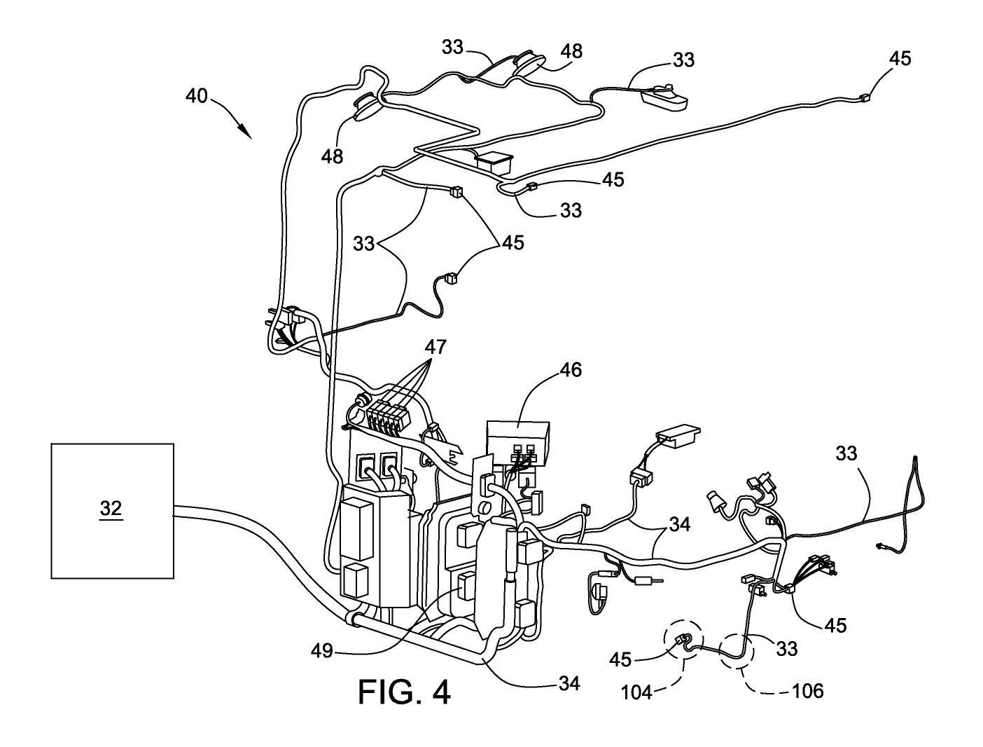

Referring to FIG. 4, a wiring harness sub-assembly 40 of cab 14 is depicted. Wiring harness sub-assembly 40 includes a plurality of electrically conductive wires 33 as well as a plurality of multi-wire cables 34 having electrically conductive wires therein. Some of the electrically conductive wires 33 may be electrically connected to electrical connectors 45 to facilitate subsequent electrical connection to other components of the machine 10. Other electrically conductive wires 33 may be terminated or electrically connected to components within or associated with the cab 14 including display 46, input devices such as switches 47, and speakers 48. Still further, the wiring harness sub-assembly 40 may further include an on-board controller such as cab controller 49. The wiring harness sub-assembly 40 may be electrically connected to other portions of machine 10 by electrical connections through main controller 32, by direct wiring, or through electrical connectors 45.

Referring back to FIG. 2, the control system 30 may include a diagnostics system generally indicated at 50 associated with wiring harness assembly 36 for determining faults that may occur that are associated with the wiring harness assembly and identifying information related to the fault. Diagnostics system 50 may include a scanning system for generating test or scan data to be used in determining an amount and a location of any impedance mismatches along the electrical paths of the wiring harness assembly 36. In one example, the scanning system may be a reflectometry system 51 (FIG. 5) that is configured to send one or more signals down each electrical path of wiring harness assembly 36 and monitor the signal or signals that are reflected back along the electrical path due to mismatches in impedance along the path. Diagnostics system 50 may also include a network manager 55 that is configured to compare impedance data or plots of the reflected signals to stored baseline impedance data or plots to determine the location of any changes in impedance along each electrical path as compared to the baseline. The changes in impedance as compared to the baseline may be used to determine the physical location of faults in the wiring harness assembly 36 along each electrical path.

As depicted schematically in FIG. 5, the reflectometry system 51 may include a signal generator 52 and a signal receiver 53 that are incorporated into or form a portion of one of the on-board controllers. The reflectometry system 51 may scan each electrical path by using the signal generator 52 and the signal receiver 53. Signal generator 52 may be configured to generate signals and transmit them down each electrically conductive wire 33 and thus each electrical path. Signal receiver 53 may be configured to receive and analyze signals that are reflected back along each electrical path. The reflectometry system 51 may be any type of system that uses reflected signals to determine the location of impedance mismatches along each electrical path of wiring harness assembly 36.

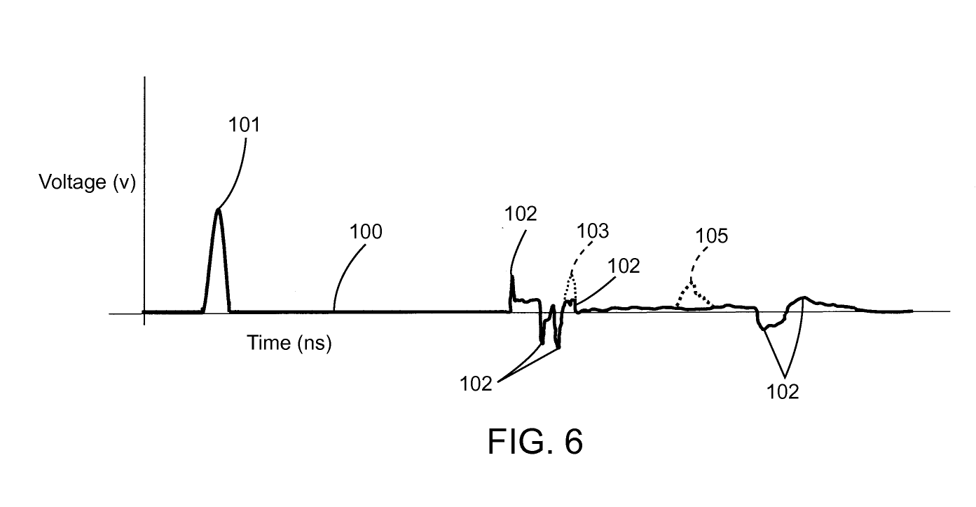

Referring to FIG. 6, a hypothetical example of a plot 100 of voltage as a function of time along an electrical path of wiring harness assembly 36 is depicted. An input signal such as a pulse 101 may be generated by signal generator 52 and transmitted down or along one of the electrically conductive wires 33. Impedance mismatches along the electrical path cause a portion of the input signal to be reflected back to the signal receiver 53. The voltage of the reflected signals is a function of the change in impedance along the electrical path. The timing of the reflected signals is a function of the distance from the signal generator 52 and signal receiver 53 to each impedance mismatch. Accordingly, the voltage of the reflected signals may be used to determine the impedance along the electrical path and the timing of the reflected signals may be used to determine the location or position of the impedance mismatches along the electrical path. For example, each of the peaks 102 is the result of an impedance mismatch in the electrical path along which the input signal was transmitted. Although the impedance data generated by the reflectometry system 51 is depicted as a plot in FIG. 6 for purposes of this description, such data may not be converted into a plot by the diagnostics system 50.

It should be noted that some impedance mismatches are expected such as those resulting from terminations to connectors, transitions from one conductor to another, and the connection to a load (e.g., motors, coils, sensors) along the electrical path. Other impedance mismatches are not expected and may result from various faults or other problems along the electrical path. Such unexpected impedance mismatches may occur due to open or short circuits, broken or loose connections, poor or worn insulation, water leaks, corrosion, excessive heat, and frayed or damages wires.

The reflectometry system 51 may further include a multiplexer system 65 having both a multiplexer and de-multiplexer operatively positioned between both of signal generator 52 and signal receiver 53 and the electrically conductive wires 33 of the wiring harness assembly 36. A signal or signals may be generated by the signal generator 52 and routed to a specific electrically conductive wire 33 by the multiplexer system 65. Similarly, the reflected signals may be received at the multiplexer system 65 and routed back to the signal receiver 53.

Through the use of multiplexer system 65, signal generator 52 and signal receiver 53 may operate to send and receive signals along a plurality of individual electrical paths, with each electrical path being connected to an electrically conductive wire 33. By electrically connecting the wiring harness assembly 36 to the reflectometry system 51, each electrical path associated with the wiring harness assembly may be scanned or tested by the reflectometry system.

In one example, the reflectometry system 51 may be configured as a spread spectrum time domain reflectometry system (“SSTDR”) as is known in the art. As such, the signal generator 52 may be configured to generate spread spectrum signals and the signal receiver 53 may be configured to receive the reflected signals and compare the reflected signals to the original signals. Regardless of the type of input signal used, the signal receiver 53 may compare the shape and timing of the reflected signals to the original or input signal or signals and to determine the position of impedance mismatches along each electrical path. In other embodiments, another portion 54 of an on-board controller may operate to compare the shape and timing of the reflected signals to the input signal or signals generated by signal generator 52 to determine the position of the impedance mismatches.

It is anticipated that other types of reflectometry systems may be used including time domain reflectometry systems (e.g., using a fast rise time pulse), frequency domain reflectometry systems (e.g., using a sine-wave signal) as well as phase detection reflectometry systems, mixed signal reflectometry systems, multi-carrier reflectometry systems, and sequence time domain reflectometry systems. However, in some applications, SSTDR may be preferred since an SSTDR system may permit the operation of the system while the machine 10 is in operation without affecting the signals passing through each conductor. More specifically, an SSTDR system may be advantageous as it may be able to operate while the machine 10 is operating and neither the machine signals nor the SSTDR signals will affect the operation of the other.

The network manager 55 may be formed as a portion of an on-board controller or operate as a controller distinct from the on-board controllers (such as main controller 32 or sub-assembly controllers 42) but electrically connected thereto by connection 61 to act an additional component of the on-board controller. The network manager 55 may include storage 56 to store a set of baseline impedance data for each conductive path of the wiring harness assembly 36. As a result, the network manager 55 may store a plurality of sets of baseline impedance data with each set of data corresponding to one of the plurality of electrical paths of the wiring harness assembly 36.

After the reflectometry system 51 scans each electrical path (i.e., generates and transmits an input signal or signals and receives the reflected signals), a set of scanned impedance data for the corresponding electrical path may be generated. The network manager 55 may compare the scanned impedance data to corresponding baseline impendence data for that electrical path. If the scanned data deviates from the baseline data by more than a predetermined amount, the network manager 55 may generate an alert signal and record details associated with the scanned data including the time and operating conditions or state of the machine 10 at the time the data was generated. Such operating conditions or state of the machine 10 may include the status of all of the systems, the function(s) being performed, the temperature of various fluids of the machine, the speed at which the machine is operating, as well as any other desired information.

In one example, the network manager 55 may generate an alert and record information related to a deviation from the baseline data if any of the peaks of the scanned data change by more than a predetermined amount (e.g., the change is greater than a predetermined percentage or greater than a predetermined number) as compared to the baseline data. Referring to FIG. 6, the dotted line at 103 reflects an increase in impedance of one of the preexisting impedance mismatches in the baseline data. As an example, such an increase in impedance at a preexisting impedance mismatch may be the result of a fault at a preexisting connection between components such as at a connection at an electrical connector 45 as identified in FIG. 4 by dotted circle 104.

In another example, an alert may be generated and information recorded if a new peak larger than a predetermined amount (e.g., a percentage or a number) occurs in the scanned data. The dotted line at 105 in FIG. 6 reflects such an increase in impedance at a location in which no impedance mismatch existed in the baseline data. As an example, such an increase in impedance at a location where an impedance mismatch did not previously exist may occur due to a fault such as a decrease in current carrying capacity of one of the electrically conductive wires 33 as identified in FIG. 4 by dotted circle 106. It should be noted that while both of the examples described above refer to increases in impedance versus the baseline data, decreases in impedance may also cause the network manager 55 to generate an alert signal and record any desired information.

Based upon a comparison of the baseline data to the scanned data, the network manager 55 may be configured to determine the physical location of any changes in the impedance mismatch between the baseline data and the scanned data. For example, if the network manager 55 determines that a sufficient deviation between the baseline data and the scanned data has occurred, the network manager may determine the location of the deviation in impedance from the baseline and record such location together with the operating conditions and other information associated with the machine 10.

Network manager 55 may also have stored therein the wiring or electrical schematics of the wiring harness assembly 36. By storing the electrical schematics of the wiring harness assembly 36 within the network manager 55 and on machine 10, maintenance on the machine may be more efficiently performed. In one example, a mechanic, technician, or other personnel may access the electrical schematics specific to the machine 10 on which they are working through the network manager 55 rather than spending time to locate the correct schematic within a database of electrical schematics. In another example, the network manager 55 may be configured to determine the portion or portions of the electrical schematics that correspond to any unexpected changes in the impedance mismatches. The network manager 55 may then direct a mechanic to the relevant portions of the electrical schematics for the wiring harness assembly 36 at which the unexpected impedance mismatch occurred. In still another example, the network manager 55 may push or automatically load the relevant portions of the electrical schematics to a portable computing device 60. In either case, the network manager 55 may highlight or otherwise call attention to relevant portions of the electrical schematics. For example, the network manager 55 may change the colors of portions of the schematics, increase the intensity of portions of the schematics, draw an identifying box around portions of the schematics, or otherwise identify the relevant portions of the schematics.

The network manager 55 may include a communications system 57 to communicate the information stored therein to a mechanic, technician, or other personnel. In one embodiment, the mechanic may access the information stored in network manager 55 with a portable computing device 60 such as a tablet, notebook computer, cell phone, augmented reality headset, or any other desired device. Communication between the network manager 55 and the portable computing device 60 may be wireless such as by Bluetooth or any other communications protocol, or through a wired connection such as with cable 62. The stored information such as the relevant portions of the electrical schematics and machine state data may be displayed on the display 63 of portable computing device 60. In another embodiment, network manager 55 may communicate the stored information to a display (not shown) of the machine 10 for viewing by the mechanic or other personnel. If desired, the stored information may be transmitted off of the machine 10 to a remote location.

Referring back to FIG. 3, wiring harness assembly 41 includes a plurality of wiring harness sub-assemblies 40 and 44. Two of the wiring harness sub-assemblies 40 include a sub-assembly controller 42 while the third wiring harness sub-assembly does not include a controller but is connected to main controller 32. The main controller 32 and the sub-assembly controllers 42 may each include a reflectometry system 51 therein or associated therewith. In such case, the reflectometry systems 51 associated with each of the sub-assembly controllers 42 may be configured to scan each of the electrical paths associated with each conductor of their respective wiring harness sub-assemblies 40. The reflectometry system 51 associated with the main controller 32 may be configured to scan each of the electrical paths associated with each conductor of the wiring harness sub-assembly. Each of the main controller 32 and the sub-assembly controllers 42 may be electrically connected to network manager 55 such as by cables 64. In the alternative, the network manager 55 may be formed as a portion of any of the main controller 32 or the sub-assembly controllers 42 and the other controllers may communicate with the controller that includes the network manager.

In an alternate configuration, the schematic drawings of the wiring harness assembly 36 may be stored remotely from the network manager 55 such as on the portable computing device 60. Upon connecting the portable computing device 60 to the network manager 55, either wirelessly or with cable 62, the network manager may communicate with the portable computing device to access or direct the technician to the portion of the electrical schematics that are relevant based upon data stored within the network manager. In still another alternate configuration, the network manager 55 may be located remotely from the machine 10 and an on-board controller may communicate wirelessly with the network manager.

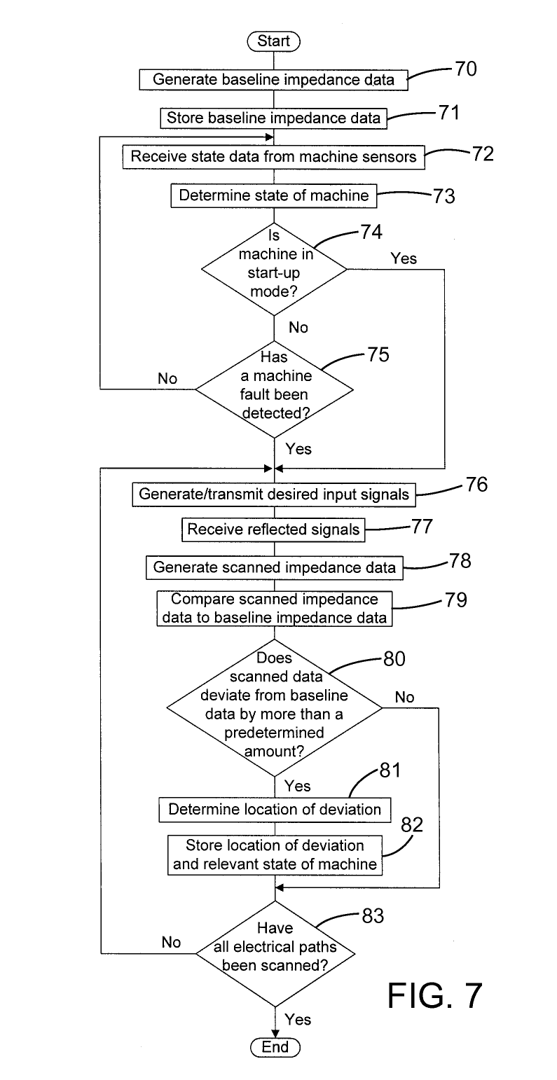

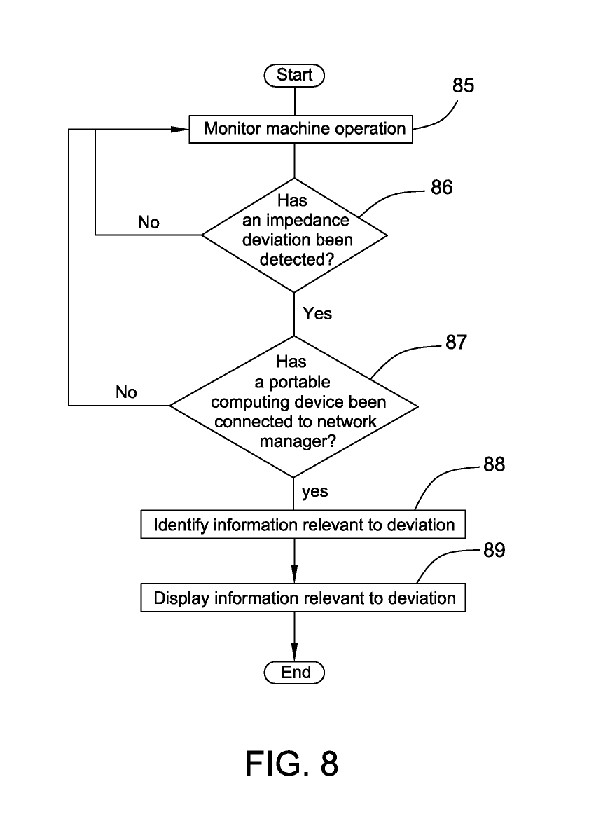

Referring to FIGS. 7-8, flowcharts of the operation of the diagnostics system 50 are depicted. At stage 70, a plurality of sets of baseline impedance data identifying the location and amount of any impedance mismatches along each electrical path of the wiring harness assembly 36 may be generated. More specifically, in one embodiment, upon assembling and confirming proper operation of a machine 10 such as at a factory, the reflectometry system 51 may scan each electrical path of the wiring harness assembly 36. The input signal together with the reflected signals may be used to generate the baseline impedance data for each electrical path of the wiring harness assembly 36.

In an alternate embodiment, a dealer or reseller of the machine may use the reflectometry system 51 to scan each electrical path of the wiring harness assembly 36 once the machine 10 arrives at the dealer. In still another alternate embodiment, the machine 10 may be modified by the dealer, the purchaser, or a third party so that the wiring harness assembly 36 is modified from the original design. Accordingly, it may be desirable for personnel at the dealer, a reseller, or a third party, or the purchaser to be able to use the reflectometry system 51 to scan each electrical path of the wiring harness assembly 36. The reflectometry system 51 (as part of the controller 31) may thus be configured to generate the plurality of baseline impedance data at each of the factory, at a dealer, and a third-party location such as a reseller, the purchaser or a third-party that modifies the machine.

Finally, if desired, standard baseline impedance data may be generated for each electrical path for each type of wiring harness assembly. This standard baseline data may be used with each machine having that type of wiring harness assembly. In some applications, it may be more desirable to utilize empirical baseline impedance data generated based upon the actual wiring harness assembly 36 in a machine 10 rather than to utilize standard baseline impedance data as each individual wiring harness assembly may have somewhat different impedance characteristics.

Once the baseline impedance data has been established, the data may be stored at stage 71 within the network manager 55 as the plurality of sets of baseline impedance data.

The controller 31 may receive at stage 72 state data from the various sensor systems 25 associated with the machine 10. At stage 73, controller 31 may use the state data to determine the status of all of the systems of the machine 10, the functions being performed by the machine, the temperature and pressure of various fluids of the machine, the speed and position of the machine, as well as any other desired information that may be relevant to diagnosing or troubleshooting faults associated with the machine.

The reflectometry system 51 may be configured to test or scan each electrical path connected to wiring harness assembly 36 at periodic or predetermined intervals and/or when a fault in a machine operation is detected. In one example, a periodic interval may be upon initialization or starting-up the machine 10 to begin operation. Controller 31 may include a series of diagnostic tests that are conducted at start-up and performing tests or scans of the wiring harness assembly 36 with the reflectometry system 51 may be part of the start-up procedure. Accordingly, the controller 31 may determine at decision stage 74 whether the machine 10 is in its start-up mode. If the machine 10 is in its start-up mode, the reflectometry system 51 of the on-board controller may be configured to begin the wiring harness assembly diagnostics process as described below. If desired, the reflectometry system 51 may be configured to run a test or scan after a predetermined period of operation (e.g., every 4 hours of operation) instead of or in addition to running the scan at start-up.

If the machine 10 is not in start-up mode at decision stage 74, the controller 31 may determine at decision stage 74 whether a machine fault has been detected. A machine fault may include any type of fault, error, or problem with any system or component of the machine 10. If a machine fault is not detected, the controller 31 may return to stage 72 and continue to monitor the state of the machine 10 and determine whether any machine faults have occurred. If a machine fault is detected at decision stage 75, the reflectometry system 51 of the on-board controller may be configured to begin the wiring harness assembly diagnostics process.

If the machine 10 is in start-up mode or a machine fault has been detected, the signal generator 52 of the reflectometry system 51 may generate and transmit at stage 76 one or more desired input signals along one of the electrical paths of the wiring harness assembly 36 through one of the electrically conductive wires 33. At stage 77 the signal receiver 53 of the reflectometry system 51 may receive reflected signals along the electrically conductive wire 33. The signal receiver 53 or another portion 54 of the on-board controller may at stage 78 generate scanned impedance data based upon the input signal or signals generated by the signal generator 52 and the reflected signals received by signal receiver 53. In one example, the scanned impedance data may include data that identifies the impedance including any changes in the impedance and their location along each electrical path of the wiring harness assembly. In another example, the data may include the impedance along the electrical path at predetermined intervals. In still another example, the data may include the impedance along the electrical path for all instances in which the impedance deviates from a determined impedance value. The data may be stored or organized in any desired manner.

The scanned impedance data may be transmitted to network manager 55 and the network manager may compare at stage 79 the scanned impedance data to the baseline impedance data for the identical or corresponding electrical path. The network manager 55 may determine at decision stage 80 whether the scanned impedance data deviates from the baseline impedance data by more than a predetermined amount.

If the scanned impedance plot deviates at decision stage 80 from the baseline impedance data by more than a predetermined amount at any location along the electrical path, the network manager 55 may determine at stage 81 the location of the change in impedance along the electrical path. The network manager 55 may make such a determination by comparing the scanned impedance data to the baseline impedance data and noting the timing of the change in impedance. Based upon the characteristics of the electrical path (such as the propagation speed of signals along the electrical path), the network manager 55 may determine the location along the electrical path of the change in impedance.

In the context of the plot in FIG. 6, the baseline impedance data corresponds to the solid line which depicts the input signal as pulse 101 and the reflected signals as peaks 102. The scanned impedance data corresponds to the baseline except it follows the two dotted line peaks 103 and 105 at those specific locations. Thus, it may be seen that the scanned impedance data deviates from the baseline impedance data at peaks 103 and 105. In other words, the scanned electrical path originally had a plurality of changes in impedance as depicted at peaks 102 of the baseline impedance data. The scanned impedance data corresponds to the baseline impedance data except at the peaks indicated by the dotted line peaks 103 and 105. The physical location along the electrical path of the deviations in impedance between the baseline data and the scanned data may be determined based upon the propagation speed of the signals and the time it took for the signals to be reflected.

At stage 82, the network manager 55 may store data related to the deviation in impedance from the baseline including the amount of deviation, the physical location along the electrical path, as well as any desired information indicative of the state of the machine as determined at stage 73. In another example in which the network manager 55 is separate from the plurality of on-board controllers (e.g., main controller 32 and/or sub-assembly controllers 42), the information regarding the state of the machine 10 may be continuously provided from the controller 31 to the network manager 55 and only stored as needed. In still another example, the information regarding the state of the machine 10 may only be provided to the network manager 55 upon a sufficiently large deviation in impedance such that an alert command is generated.

If the scanned impedance data does not deviate from the baseline impedance data by more than a predetermined amount at decision stage 80, or upon completion of stage 82, controller 31 may determine at decision stage 83 whether a scan has been performed on each of the electrical paths of the wiring harness assembly 36. In an alternate embodiment, the network manager 55 may determine whether a comparison between the baseline impedance data and the scanned impedance data has been performed for each of the electrical paths of the wiring harness assembly 36. If all of the electrical paths have not been scanned or all of the data has not been compared, the process beginning at stage 76 may be repeated until completion of the process for each of the electrical paths of the wiring harness assembly 36.

Referring to FIG. 8, stages 70-83 of FIG. 7 are characterized as setting the baseline impedance data and monitoring the operation of the machine 10 and identified as stage 85. At decision stage 86, the network manager 55 may determine if an impedance deviation greater than a predetermined amount has been detected at stage 85 and the scanning process completed for each electrical path of the wiring harness assembly 36. If an impedance deviation has not been detected and the scanning process has not been completed, the process may continue at stage 85 until both occur. Once both an impedance deviation has been detected and the scanning process has been completed, the network manager 55 may determine at decision stage 87 whether a portable computing device 60 has been connected to the network manager. If a portable computing device 60 has not been connected, operation of the machine 10 may continue and the process may return to stage 85 and continue to monitor the state of the machine and determine whether any machine faults have occurred.

If a portable computing device 60 has been connected to network manager 55, the network manager may identify and transmit to the portable computing device at stage 88 information that is related to the deviation in impedance along the electrical path. This information may include the amount and type of deviation in impedance, the state of the machine 10 at the time of the deviation, portions of the electrical schematics that are relevant to the location of the impedance deviation, and any other information that may be desired or useful to the technician. The technician may then display at stage 89 any of the information as desired on the display 63 of portable computing device 60.

### INDUSTRIAL APPLICABILITY

The industrial applicability of the system described herein will be readily appreciated from the foregoing discussion. The foregoing discussion is applicable to any type of machine 10 having a wiring harness assembly 36. The diagnostics system 50 operates to scan the impedance along each of the electrical paths of the wiring harness assembly 36 to generate scanned impedance data and then compares the scanned impedance data to corresponding baseline impedance data that is stored within controller 31. Upon an impedance deviation between the scanned impedance data and the baseline impedance data exceeding a predetermined amount, the location along the electrical path(s) corresponding to the impedance deviation is determined and the operating conditions of the machine 10 corresponding to the timing of the scan is stored. Portions of the electrical schematic related to the location of the impedance deviation is identified and may be displayed.

The configuration of the diagnostics system 50 provides numerous advantages. The wiring harness assembly 36 may be tested or scanned with access to only one end of each electrical path. In other words, the wiring harness assembly 36 may be analyzed while in place on the machine 10 and interconnected to the various components and systems of the machine. Depending on the type of diagnostics system 50 being used, testing or scanning of the wiring harness assembly 36 may occur during operation of the machine 10 without impacting the operation of the machine or the scanning of the wiring harness assembly. For example, when using a reflectometry system 51 such as a SSTDR, the test or input signals and the reflected signals may be small enough so as not to affect any of the systems of the machine. In addition, the input signals used by the reflectometry system 51 may be configured so that the signals sent over the wiring harness assembly 36 by controller 31 to operate machine 10 do not affect the operation of the reflectometry system.

In addition, the diagnostics system 50 may improve the efficiency of technicians maintaining or fixing the machine 10. The diagnostics system 50 uses changes in impedance deviations to identify portions of the electrical schematics that may be relevant to the task of locating the source of machine faults. If a machine fault is the result of a fault or impedance discontinuity in the wiring harness assembly 36, the diagnostics system 50 may identify the location of the fault on the electrical schematics. This may save the technician time in locating the relevant portions of the schematics. Still further, if the electrical schematics are stored on the machine 10, such as within network manager 55, the technician does not need to search a database for the correct wiring harness assembly 36 and its related electrical schematics. Instead, the technician has access to the correct information directly from the network manager 55.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A diagnostics system for use with a wiring harness assembly mounted on a machine, comprising:
a plurality of sensor systems for determining a plurality of operating conditions of the machine;
a scanning system for determining impedance along an electrical path of the wiring harness assembly;
a controller configured to:
(a) store a plurality of sets of baseline impedance data, each set of baseline impedance data corresponding to one of a plurality of electrical paths of the wiring harness assembly;
(b) store an electrical schematic of the wiring harness assembly;
(c) determine the plurality of operating conditions of the machine based upon the plurality of sensor systems;
(d) scan impedance along a selected one of the plurality of electrical paths of the wiring harness assembly to generate scan data;
(e) generate a set of scanned impedance data from the scan data;
(f) compare the set of scanned impedance data to a selected one of the plurality of sets of baseline impedance data, the selected one of the plurality of sets of baseline impedance data corresponding to the selected one of the plurality of electrical paths of the wiring harness assembly;
(g) upon an impedance deviation between the set of scanned impedance data and the set of baseline impedance data exceeding a predetermined amount:
(i) determine a location along the selected one of the plurality of electrical paths of the wiring harness assembly corresponding to the impedance deviation; and
(ii) store the plurality of operating conditions of the machine corresponding to a time at which the scan data was generated;
(h) repeat steps (c)-(g) until each of the plurality of electrical paths of the wiring harness assembly has been scanned; and
(i) identify portions of the electrical schematic related to the location along the selected one of the plurality of electrical paths of the wiring harness assembly corresponding to the impedance deviation.

2. The diagnostics system of claim 1, wherein the scanning system includes a reflectometry system having a signal generator for generating input signals and a signal receiver for receiving reflected signals, and the controller is further configured to transmit at least one input signal along the selected one of the plurality of electrical paths of the wiring harness assembly and receive reflected signals from the selected one of the plurality of electrical paths of the wiring harness assembly, and generate the set of scanned impedance data from the reflected signals.

3. The diagnostics system of claim 1, wherein the controller is on-board the machine.

4. The diagnostics system of claim 1, wherein the wiring harness assembly includes a plurality of on-board controllers and each on-board controller is configured to perform steps (d) and (e) with respect to a portion of the wiring harness assembly.

5. The diagnostics system of claim 4, wherein the controller further includes a network manager, with each of the plurality of on-board controllers configured to transmit scanned impedance data to the network manager, and steps (f), (g), and (h) are performed by the network manager.

6. The diagnostics system of claim 5, wherein the network manager is configured to communicate with a portable computing device.

7. The diagnostics system of claim 5, wherein the network manager is a portion of one of the plurality of on-board controllers.

8. The diagnostics system of claim 1, wherein the controller is configured to perform steps (c)-(h) on predetermined intervals during operation of the machine.

9. The diagnostics system of claim 1, wherein the controller is configured to perform steps (c)-(h) upon machine start-up.

10. The diagnostics system of claim 1, wherein the controller is configured to perform steps (c)-(h) upon detecting a machine fault.

11. The diagnostics system of claim 1, wherein controller is further configured to generate the plurality of baseline impedance data at each of a factory, at a dealer, and a third-party location.

12. The diagnostics system of claim 1, wherein the electrical schematic of the wiring harness assembly is stored within a network manager that is a portion of an on-board controller.

13. The diagnostics system of claim 1, wherein the electrical schematic of the wiring harness assembly is stored at a location remote from the machine.

14. A controller-implemented method of operating a diagnostics system for use with a wiring harness assembly mounted on a machine, comprising:
(a) storing a plurality of sets of baseline impedance data, each set of baseline impedance data corresponding to one of a plurality of electrical paths of the wiring harness assembly;
(b) storing an electrical schematic of the wiring harness assembly;
(c) determining a plurality of operating conditions of the machine based upon a plurality of sensor systems;
(d) scanning impedance along a selected one of the plurality of electrical paths of the wiring harness assembly to generate scan data;
(e) generating a set of scanned impedance data from the scan data;
(f) comparing the set of scanned impedance data to a selected one of the plurality of sets of baseline impedance data, the selected one of the plurality of sets of baseline impedance data corresponding to the selected one of the plurality of electrical paths of the wiring harness assembly;
(g) upon an impedance deviation between the set of scanned impedance data and the set of baseline impedance data exceeding a predetermined amount:
(i) determining a location along the selected one of the plurality of electrical paths of the wiring harness assembly corresponding to the impedance deviation; and
(ii) storing the plurality of operating conditions of the machine corresponding to a time at which the scan data was generated;
(h) repeating steps (c)-(g) until each of the plurality of electrical paths of the wiring harness assembly has been scanned; and
(i) identifying portions of the electrical schematic related to the location along the selected one of the plurality of electrical paths of the wiring harness assembly corresponding to the impedance deviation.

15. The method of claim 14, wherein the step of scanning impedance includes transmitting at least one input signal along the selected one of the plurality of electrical paths of the wiring harness assembly and receiving reflected signals from the selected one of the plurality of electrical paths of the wiring harness assembly, and the step of generating the set of scanned impedance data uses the reflected signals.

16. The method of claim 14, further including a plurality of on-board controllers each performing steps (d) and (e) with respect to a portion of the wiring harness assembly.

17. The method of claim 16, further including each of the plurality of on-board controllers transmitting scanned impedance data from the on-board controllers to a network manager, and the network manager performing steps (f), (g), and (h).

18. The method of claim 17, further including storing the electrical schematic of the wiring harness assembly on-board the machine within the network manager.

19. The method of claim 14, further including performing steps (c)-(h) upon machine start-up and upon detecting a machine fault.

20. A machine comprising:
a frame;
a prime mover associated with the frame;
a wiring harness assembly mounted on the frame and including a plurality of electrical paths;
a plurality of sensor systems for determining a plurality of operating conditions of the machine;
a scanning system for determining impedance along each of the electrical paths of the wiring harness assembly; and
a controller configured to:
(a) store a plurality of sets of baseline impedance data, each set of baseline impedance data corresponding to one of a plurality of electrical paths of the wiring harness assembly;
(b) store an electrical schematic of the wiring harness assembly;
(c) determine the plurality of operating conditions of the machine based upon the plurality of sensor systems;
(d) scan impedance along a selected one of the plurality of electrical paths of the wiring harness assembly to generate scan data;
(e) generate a set of scanned impedance data from the scan data;
(f) compare the set of scanned impedance data to a selected one of the plurality of sets of baseline impedance data, the selected one of the plurality of sets of baseline impedance data corresponding to the selected one of the plurality of electrical paths of the wiring harness assembly;
(g) upon an impedance deviation between the set of scanned impedance data and the set of baseline impedance data exceeding a predetermined amount:
(i) determine a location along the selected one of the plurality of electrical paths of the wiring harness assembly corresponding to the impedance deviation; and
(ii) store the plurality of operating conditions of the machine corresponding to a time at which the scan data was generated;
(h) repeating steps (c)-(g) until each of the plurality of electrical paths of the wiring harness assembly has been scanned; and
(i) identify portions of the electrical schematic related to the location along the selected one of the plurality of electrical paths of the wiring harness assembly corresponding to the impedance deviation.
